(19) United States
(12) Patent Application Publication
(10) Pub. No.: US 2002/0150099 A1
(43) Pub. Date: Oct. 17, 2002

(54) Multicast routing method satisfying quality of service constraints, software and devices

(76) Inventors: Hung Keng Pung, Singapore (SG); Jun Song, Nan Jing (CN)

Correspondence Address: Killworth, Gottman, Hagan & Schaeff, L.L.P., Suite 500, One Dayton Centre, Dayton, OH, 45402-2023, US

(21) Appl. No.: 10/121,253

(22) Filed: Apr. 12, 2002

Related U.S. Application Data
(60) Provisional application No. 60/283,370, filed on Apr. 13, 2001.

(51) Int. Cl. H04L 12/28; H04L 12/56

(52) U.S. Cl. 370/390; 370/432

(57) ABSTRACT

A multicast routing method satisfying quality of service constraints, devices and software are disclosed. A route requester may initiate establishment of a multicast route on a network to a multicast source node. Routing request messages are broadcast by a node receiving the request to adjacent nodes. Upon arrival of a request message at each node, QoS constraints are tested to ensure that a multicast path satisfying the QoS constraints may include this node. If so, resources at the node are tentatively reserved, and the request message is propagated to adjacent nodes. If not, a message is propagated in the reverse direction, releasing all tentative reserved resources at downstream nodes until a node through which another path to the multicast source has been routed or is tentatively reserved (i.e. a branch node) is encountered along the path. The process is repeated at each node, as routing messages are propagated in multiple directions away from the requester. Equivalent routing requests at any node may be merged. Similarly, in the event a route through a node to the multicast source already exists, a routing request may merge a requested route with an existing route, downstream (i.e. toward the multicast source) of the node, thereby attaching to an existing branch within the multicast routing tree. Once a routing message arrives at the source or at a node that merges an existing route to the source, this source or merge node confirms routing by dispatching a confirmation message to the requesting node, along the tentatively reserved route.

### CROSS-REFERENCE TO RELATED APPLICATIONS

This application claims benefits from U.S. Provisional Patent Application No. 60/283,370 filed Apr. 13, 2001, the contents of which are hereby incorporated herein by reference.

### FIELD OF THE INVENTION

The present invention relates generally to communications networks, and more particularly to methods, devices and software for establishing network routes for multicasts, satisfying quality of service constraints.

### BACKGROUND OF THE INVENTION

Multicasting, as used herein, refers to the transmission of the same information packets by a source to a multiplicity of receivers in a packet switched communications network.

There are two major steps in multicasting: multicast routing for establishing the desirable connection, and data forwarding for switching of packets at each intermediate switching nodes along the path. Multicast routing establishes a delivery route through which information packets can be exchanged efficiently among participants (senders and receivers).

A common approach to multicast routing establishes a multicast tree that includes a connected set of network switching nodes and links, including switching nodes to which users are directly connected. The tree, when implemented as a shared tree, implies a peer relationship among users. As such, each user can typically act as a sender as well as a receiver, and hence the tree typically supports full-duplex transmissions logically.

Nevertheless, methods of efficient resource allocation and sharing over the tree remain an open research issue, especially when the dynamism of membership is high.

Most present multicast services are server-client based with asymmetrical traffic flow, in which the source sends information to the group of receivers most of the time. These kinds of multicast services are typically supported by a source rooted multicast tree, wherein the information source-node is the root of the tree and the receiver-nodes are its leaves.

As such, receiver (i.e. leaf) initiated joining and leaving of multicast trees is more pragmatic, flexible and scaleable than source based routing. A user wishing to join the service can request a route to the multicast address; likewise the user may leave the service by requesting a request to ‘leave’.

Adding to routing complexity is the fact that many applications, such as multimedia conferencing, computer supported cooperative work (“CSCW”) and video-on-demand services further require multicast with a defined Quality of Service (QoS). QoS requirements of such multicasts are often specified as multiple constraints expressed in terms of delay, delay jitter, bandwidth, loss rate, cost and so on. A multicast route satisfying multiple QoS constraints must therefore establish a feasible multicast tree that has sufficient resources to satisfy all QoS constraints.

Known methods for QoS multicast routing are based on graph theory and link-state information. The routing consists of two basic tasks. The first task is to collect the state information and keeps it up to date. The second task is to compute feasible paths based on the collected state information and topology information.

These known algorithms can be classified as constrained Steiner tree and constrained shortest path algorithms. The Steiner tree algorithm is to find the least-cost tree covering a group of destinations with the minimum total cost over all links. The constrained Steiner tree algorithm is to construct a least-cost tree with bounded delay. Unfortunately, both the Steiner tree and the constrained Steiner tree are well-known NP-complete problems. They typically cannot support dynamic routing and multiple QoS constraints. The constrained shortest path algorithms minimise the cost of each path from the source to a destination without violating the end-to-end delay constraints. It is also a NP-complete problem when there are more than one path constraints.

Although many heuristics algorithms have been proposed to reduce the computational complexity, their premises that every node has the updated information for link-state and multicast tree are unrealistic and impractical.

Accordingly, methods and devices facilitating multicast routing satisfying multiple QoS constraints are desirable.

### SUMMARY OF THE INVENTION

It is therefore an object of the present invention to provide an efficient method of multicast routing satisfying multiple QoS constraints.

Exemplary QoS routing may be used in a wide range of multicast communications involving distributed real-time multimedia data with guaranteed quality of service. Conveniently, the exemplary methods also allow multicast routing of non real-time data requiring only best effort delivery through the same multicast routing framework for real-time data requiring QoS-based routing. Developers of network applications such as video conferencing, network TV/radio and video on demand, should appreciate such QoS routing, which is currently not available.

Conveniently, methods exemplary of the present invention allow establishment of a multicast tree between a source (or root) and a group of receivers over a network with a plurality of connected nodes. Advantageously, the resulting tree may meet QoS constraints, such as bandwidth, end-to-end delay, end-to-end delay jitter, cost and so on. Conveniently, such methods may allow one root sender to N receivers (1:N-way) multicast, as well as a half-duplex N-way QoS multicast allowing any member of the multicast group, one at a time, to multicast multimedia data.

A receiver may join a multicast service independently and dynamically, so long as a multicast service has been identified. A receiver wishing to join a multicast may generate a request packet to the network through its receiver-node. Nodes on the network duplicate the request packet to search possible routes in parallel and select a confirmed qualified route within a short set-up time.

Additionally, bounded routing may limit the hop count each request packet can travel toward the source of the multicast, reducing the number of duplicated request packets.

Preferably, a two-state resource reservation resolution is used. When a node receives a routing request packet, it tentatively reserves the required resource in ‘soft-state’. In this state, the tentatively reserved resource can still be utilised by the best-effort traffic that requires no prior reservation, but the resource is not available for reservation by other new QoS routing requests. Only when the node receives a confirm packet, does it commit the required resource for this route, that is said to reserve resource in ‘hard-state’. Advantageously, tentatively reserved resources of nodes not belonging to the final selected route are released quickly during routing, thereby increases the probability of successful routing of other requests.

Optionally, a receiver may leave the multicast service independently and dynamically.

In accordance with an aspect of the present invention, a method of operating a node within a packet switched network includes receiving a route request including a QoS constraint, to establish a multicast route through the node; determining if another multicast route to the source satisfying the constraint and including the node is or may be established through the node; and merging the multicast route with the another multicast route to provide the multicast route through the node.

In accordance with another aspect of the present invention, a method of operating a node within a packet switched network, in order to establish a route to a multicast source, includes receiving a route request at the node, the route request includes at least one constraint for the route to the multicast source; determining if another multicast route to the source satisfying the constraint and including the node has been established through the node; if no other multicast route to the source satisfying the constraint and including the node has been established through the node, repeating the route request downstream to ports of the node satisfying the at least one constraint.

In accordance with another aspect of the present invention, there is provided, in a communications network, in which multicast routes from a source may be established, a method of processing a route confirmation that is redundant at a node and deleting a corresponding branch on the network. The branch extends from the node to another node on an established path to the source. The method includes receiving at the node, the route confirmation message confirming an earlier route requested to the source along the branch; determining another multicast route to the source has already been established at the node prior to the receiving of the confirmation message and in response, dispatching a message along the branch, to delete reservations of resources for the branch on the network.

In accordance with another aspect of the present invention, a method of establishing a multicast route at a node within a network includes receiving a request to establish the route, the request including at least one constraint; determining if reservation of resources along another route via the node to the source and satisfying the constraint, is pending; buffering the request until the reservation of resources along the other route are confirmed; upon confirming reservation of the resources along the other route at the node, merging the route with the other route from the node to the source.

In accordance with another aspect of the present invention, a method of establishing a multicast route to a source, through a node within a communications network includes receiving a confirmation message that the route may be established through the node, the confirmation message includes an indicator for assessing QoS constraints along the route; using the indicator to assess a QoS of the route from the multicast source to the node; committing previously tentatively reserved resources for other routes to the source through the node having quality of service constraints satisfied by the assessed quality of service; releasing previously tentatively reserved resources for other routes to the source through the node having quality of service constraints not satisfied by the assessed quality of service.

In accordance with another aspect of the present invention, a method of establishing a multicast route at a node within a network incldues receiving a request to establish the route, the request including at least one constraint; determining the request is received from another node on an existing established route to the source; discarding the request.

In accordance with another aspect of the present invention, a method of operating a node within a packet switched network, in order to establish a route to a multicast source, the route including at least one port connecting the node to the network. The method includes receiving a message at the node, from a downstream node, indicating that a route through the port as requested by a route request will not meet a desired QoS; releasing tentatively reserved resources for the port at the node, the tentatively reserved resources reserved for the route and for other routes having QoS constraints stricter than the desired QoS; and passing messages upstream along the route and the other routes, indicating tentatively reserved resources should be deleted upstream of the node.

In accordance with another aspect of the present invention, a method of disconnecting a computing device from a multicast routing tree in a packet switched network, the method includes receiving a message to from the computing device, representative of the multicast asynchronously; repeating the message along a previously established branch connected to the tree; releasing resources reserved at the node along the branch.

In accordance with another aspect of the present invention, a method of establishing a multicast route satisfying at least one constraint, on a packet switched network, to transmit multicast data from a source to a receiver includes: originating a request to establish a route at the receiver; flooding the request to nodes downstream of the receiver; assessing if the at least one constraint is satisfied at the downstream nodes; sending prune-back messages upstream toward the receiver, at nodes not satisfying the constraints; forwarding the request downstream at nodes satisfying the constraint; merging the route with an existing multicast route at a branch node along an existing multicast route toward the route, satisfying the constraints; sending a confirmation message upstream toward the receiver from the branch node.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 illustrates a data network including nodes exemplary of embodiments of the present invention;

FIGS. 2A-2B and 3A-3B illustrate exemplary tables maintained at the nodes of FIG. 1;

FIGS. 4A-4B illustrate exemplary packets forwarded on the network of FIG. 1, in order to establish multicast routes in manners exemplary of embodiments of the present invention;

FIGS. 5A, 6A, 7A and 8A illustrate flow charts of steps performed at nodes of the network of FIG. 1 in establishing multicast routes in manners exemplary of embodiments of the present invention;

FIGS. 5B, 6B, 7B, and BB illustrate pseudo-code corresponding to the flow charts of FIGS. 5A, 6A, 7A and 8A;

FIGS. 9A-9H, 10 and 11A-11C illustrate the flow of packets at an exemplary node of FIG. 1; and

FIGS. 12A-12F; 13A-13E; and 14A-14F illustrate exemplary routing flow on the network of FIG. 1, exemplifying an embodiment of the present invention in operation.

### DETAILED DESCRIPTION

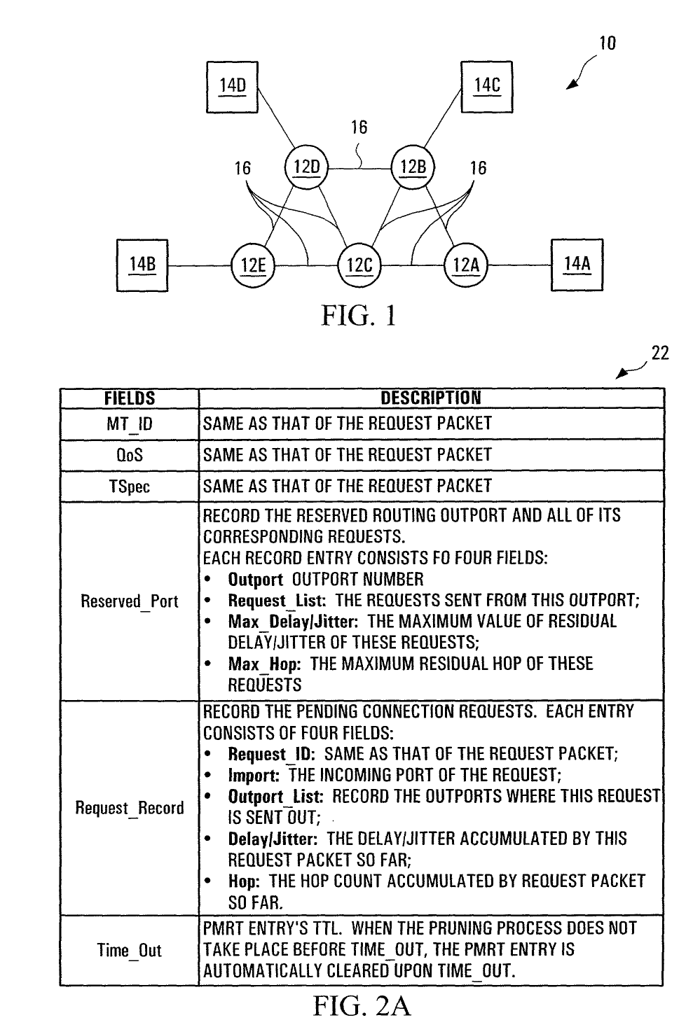

FIG. 1 illustrates an exemplary packet switched data network 10, including a plurality of network nodes 12a, 12b, 12c, 12d and 12e (individually and collectively referred to as node(s) 12). Nodes 12 may be conventional routers, switches, or the like adapted in manners exemplary of the present invention. Nodes 12 are interconnected with each other by way of data links 16, capable of transporting traffic between interconnected nodes. Nodes 12, in turn, may route or switch packetized data, using source and destination information contained in these packets. Nodes 12 may, for example, be operable to route internet protocol (IP) packets, as for example, detailed in Internet Engineering Task Force RFC 791, et seq.

Each of nodes 12 includes one or more ports for receipt and transmission of data, in communication with a processor under software control, by way of software stored in computer memory at the router. Suitable software, adapting each of nodes 12 to act as a conventional router and to function in manners exemplary of embodiments of the present invention may be loaded into memory at node 12 from an appropriate computer readable medium into non-volatile memory at node 12.

Software at nodes 12 adapts nodes 12 to establish QoS constrained based multicast routes on network 10, for exchange of data between computing devices in communication with routers 12, exemplary of embodiments of the present invention. Example computing devices 14a, 14b, 14c and 14d (individually and collectively computing devices 14) are also schematically illustrated in FIG. 1. Computing devices 14 may be conventional end-user computing devices, enterprise computing servers, network servers, or any other computing devices. As exemplified, computing devices 14 are capable of transmitting and receiving multicast data. Such data may, for example, be used for transport of multi-media information; video conferencing; television, radio and video, on demand; and the like.

Exemplary of the present invention, nodes 12 recognize routing packets for establishment of multicast routes, resulting in multicast trees that allow multicasting satisfying QoS constraints. In overview, a computing device 14 at the edge of network 10 acting as a route requester may initiate establishment of a multicast route on a network to a multicast source node. Routing request messages are broadcast by a node 12 receiving the request to adjacent downstream nodes 12. Upon arrival of a request message at each node 12, QoS constraints are tested to ensure that a multicast path satisfying the QoS constraints may include this node. If so, resources at the node 12 are tentatively reserved, and the request message is propagated to adjacent nodes 12, downstream in the direction away from the route requester. If not, a message is propagated in the reverse direction, releasing all tentative reserved resources at upstream nodes until a node through which another path to the multicast source has been routed or is tentatively reserved (i.e. a branch point) is encountered along the path. The process is repeated at each node 12, as routing messages are propagated in multiple directions away from the requester.

Equivalent routing requests at any node may be merged. In the event a route through a node 12 to the multicast source already exists, a routing request may merge a requested route with an existing route, downstream (i.e. toward the multicast source) of the node, thereby attaching to an existing branch within the multicast routing tree. Once a routing message arrives at the source or at a node that merges an existing route to the source, this source or merge node confirms routing by dispatching a confirmation message to the requesting node, back along the tentatively reserved route.

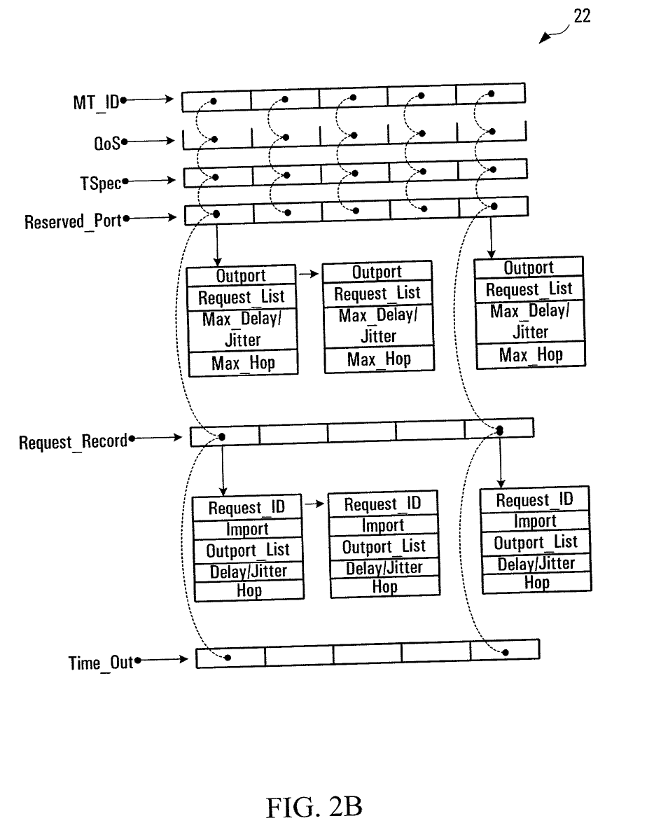

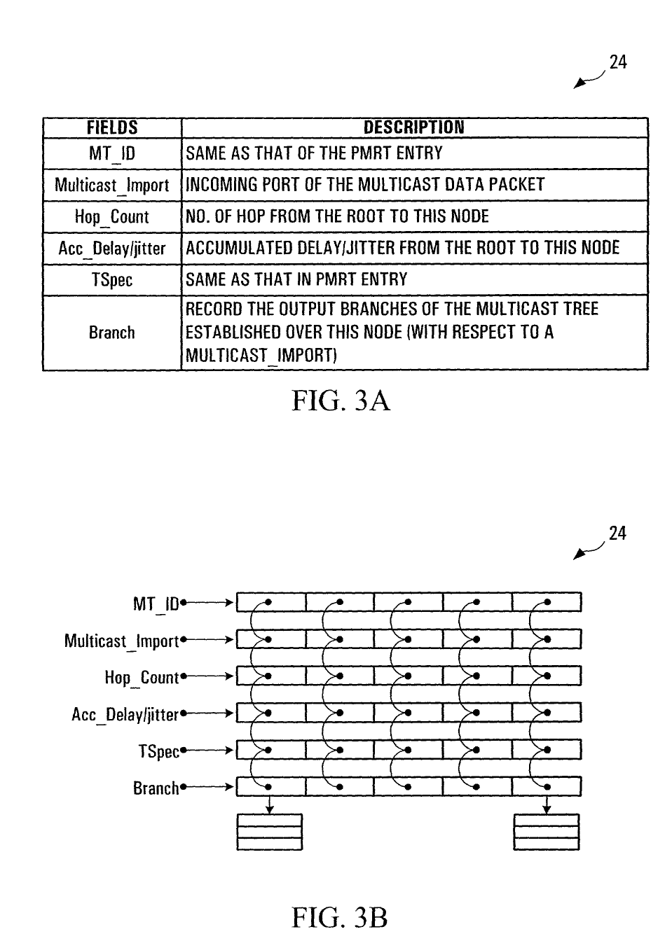

Routing information for established routes, and to-be established routes are preferably maintained within tables at each of the nodes 12. As will become apparent, the tables are updated dynamically as routes are established. Exemplary tables stored at each node 12 are illustrated in FIGS. 2A-2B and 3A-3B.

In the example embodiment, five types of tables are maintained at each node 12 for admission control, routing and related procedures during the setting up of multicast trees, and bookkeeping of available resources.

First is a ‘Pending Multicast Routing Table’ (PMRT) 20, in which each entry represents a reserved, but not yet confirmed, multicast route through the node and contains the fields shown in FIG. 2A. A possible data structure of a PMRT is shown in FIG. 2B.

Second is a ‘Multicast Routing Table’ (MRT) 22 in which each entry records an established and confirmed multicast route through the node. Exemplary fields are detailed in FIG. 3A. A possible data structure of an MRT is shown in FIG. 3B.

Another log table (not specifically illustrated) records routing requests received by that node and may be used to avoid looping of the same request packet in the process of routing. Each entry of the log table is preferably automatically purged after a pre-determined timeout period. The timeout period can be set to the average maximum connection set-up time in a given network.

A further resource table at each node inventories resources at the node (e.g. ports, links, etc.) available for sharing. For each resource, this table keeps track of the total amount of the resource, the amount of resources tentatively reserved and reserved with confirmation respectively, and the residual resources, which are free for allocation.

As will become apparent, to reduce routing overhead of routing request packets, a bounding technique, which restricts the number of hops each request packet can travel toward the root of the multicast tree (i.e. the multicast source) may be employed. As such, each node may maintain a hop-distance table for fine-grain hop control. The table may store the minimum-hop distance through each port to every other node on network 10. This hop distance can easily be calculated by using Dijkstra's shortest-path algorithm or Bellman-Ford shortest-path algorithm according to topology information. However, the hop table may not be required in the absence of the fine-grain hop control. Instead, each request packet including a hop counter may be allowed to travel up to the radius of maximal permissible hop from the requester before being purged by the respective node from the network.

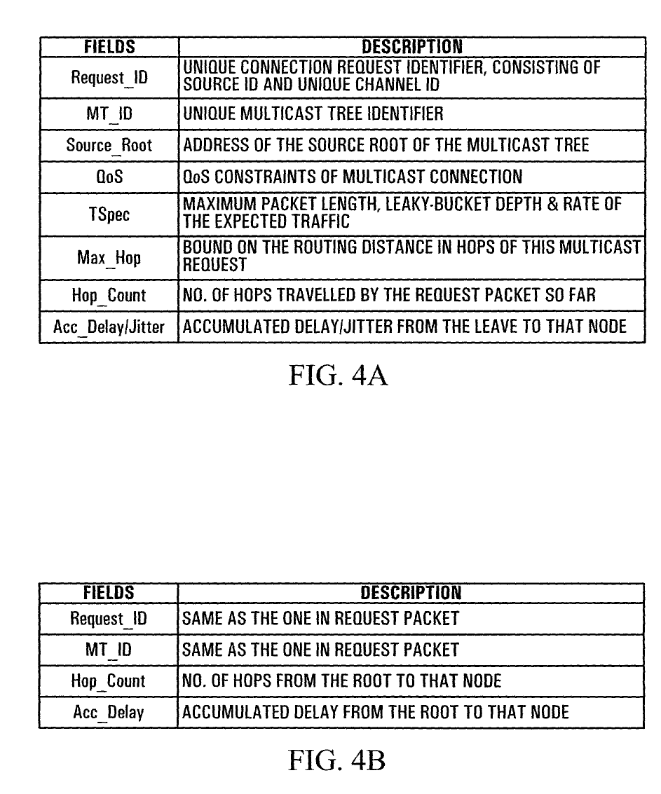

In the exemplary embodiment, four packets types are used to establish multicasts routes. Example packet formats are illustrated in FIGS. 4A and 4B. These are request packets (Req) (FIG. 4A), confirmation packets (Cf) (FIG.4B), prune-backward packets (PrB) (not specifically illustrated) and prune-branch packets (PBR) (also not specifically illustrated). Each node processes routing requests in dependence on the routing packet type.

The QoS field in the request packet (FIG. 4A) includes QoS constraints of the request bounded by that of the source traffic. QoS constraints may, for example, include one or more of minimum bandwidth, maximum delay, maximum delay jitter, and others. The traffic specification (Tspec) in the request packet describes the characteristics of the source traffic, which may be used by the node scheduling algorithm to compute its delay and delay jitter bounds and the required resources. For example, the traffic specification may include maximum packet length, leaky bucket depth, and rate of the requested multicast.

PrB and PBR packets may only include field Request_ID and MT_ID, having values corresponding to those in corresponding Req and Cf packets. PrB and PBR packets are thus not specifically illustrated.

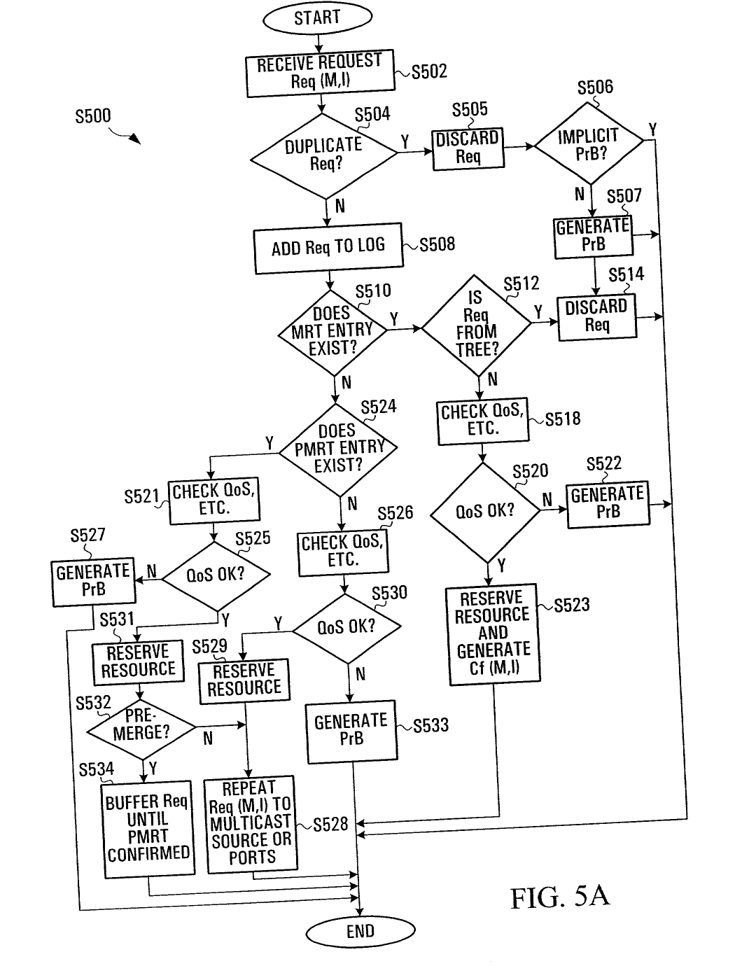

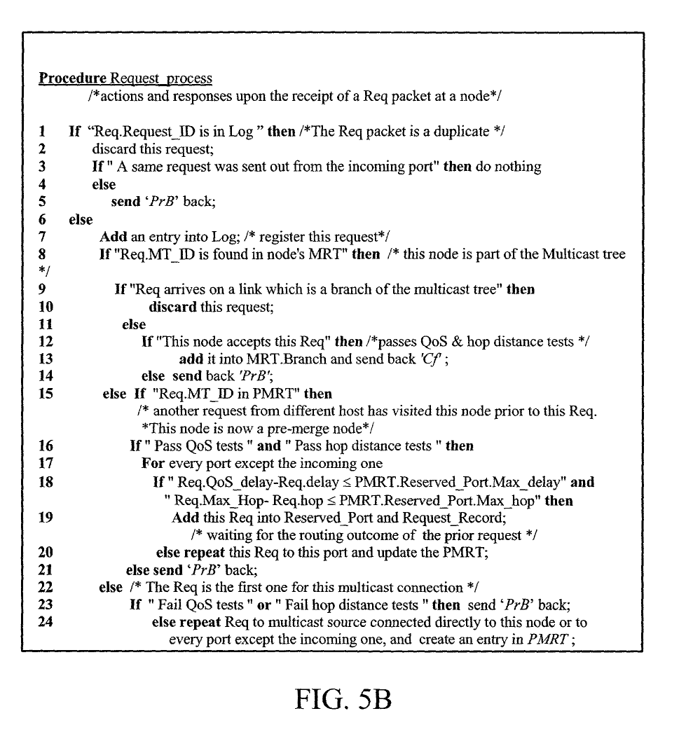

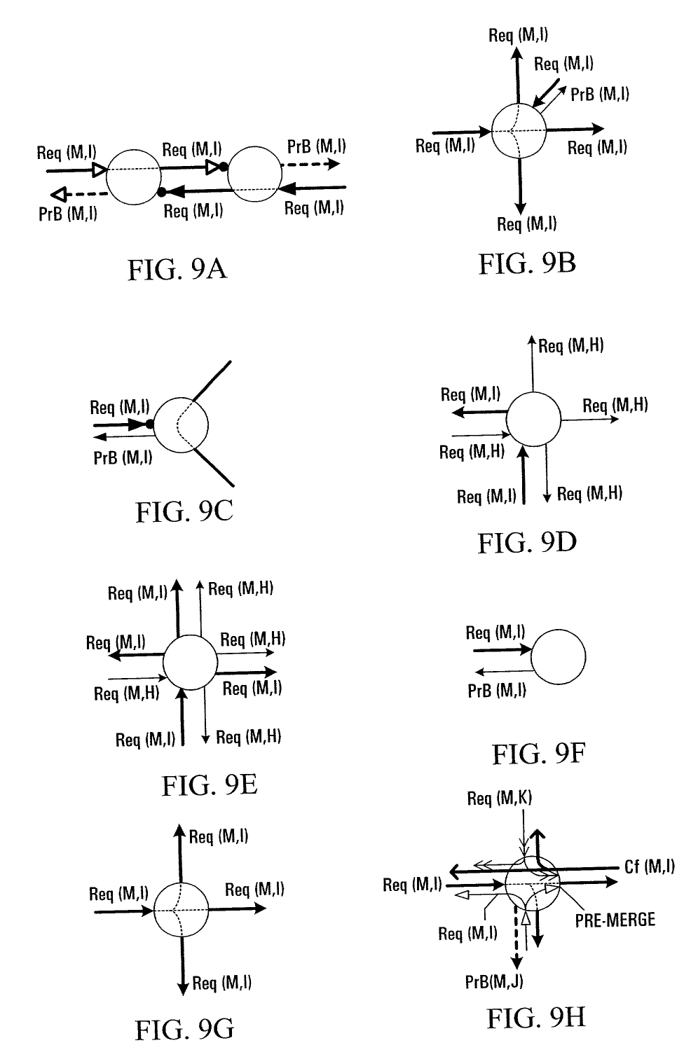

Steps performed by a node in response to receipt of routing packets are illustrated in FIGS. 5A, 6A, 7A and 8A. Corresponding example pseudo code is illustrated in FIGS. 5B, 6B, 7B and 8B. Corresponding packet flow at any one node 12 in route establishment is illustrated in FIGS. 9A-9H; 10; and 11A-11C.

Upon receipt of a Req(M,I) packet, steps S500 illustrated in FIGS. 5A and 5B are performed. Req(M,I) identifies a multicast by source (M) and channel (I). Steps S500 determine whether to accept and confirm a route request if it is an attachment point of an existing multicast tree; to perform a pre-merge if a related routing is in progress; or to reserve resources and route the request message Req(M,I) to all its suitable out ports if the request is new.

Specifically, when a Req (M,I) packet arrives at a node in step S502, the node first checks if the Req (M,I) is a duplicate request by comparing the request to entries of its log table (FIG. 5B-line 1) in step S504. If the request is a duplicate, the node discards this request in step S505 and continues to check in step S506 if the previously received request Req(M,I) was routed to the port on which the duplicate Req(M,I) was received (FIG. 5B-line 3). If so, the node 12 un-commits the tentatively reserved resources for the previous request and sends a PrB message to prune that previous request further upstream if necessary. This is referred to as an ‘implicit prune-back’ of the path. Example packet flow for implicit prune-back at node 12 is illustrated in FIG. 9A. If the duplicate request, as determined in step S506 was not received on the same port, the node prunes back the tentative route along which the request Req(M,I) was received by sending a PrB message to prune Req(M,I) upstream in the direction of the requester in step S507 (FIG. 5B-line 5). Example packet flow for such prune-back at node 12 is illustrated in FIG. 9B.

If the request is not a duplicate, node 12 stores the request in its log table in step S508. Now, if the node has already been confirmed as part of a multicast tree (FIG. 5B-line 8) to source (M) and channel (I), as determined in step S510, node 12 determines if the incoming request originates on the tree. If the request arrives along a branch on the existing tree (FIG. 5B-line 9), as determined in step S512, the node discards the request in step S514.

If the request does not arrive on an existing branch as determined in step S512, the node checks that the QoS for the request are satisfied by the node (and therefore by the existing tree) in steps S518 and S520. Additionally, the node may optionally check that the request satisfies any maximal hop count, as detailed below. If so, the node reserves resource and dispatches a confirm packet Cf(M,I) to the port from which Req(M,I) message was received in step S523 thereby merging the existing multicast tree with the requested route.

If the QoS constraints cannot be satisfied at the node, the node sends a prune back packet (FIG. 5B-line 14) in the direction of the source of the request in step S522. Example packet flow is illustrated in FIG. 9C

If a tentatively reserved path that has not yet been confirmed and corresponds (i.e. same source(M) and channel(l)) to the request, already exists at node 12 as determined in step S524 with reference to the PMRT at that node 12, the node checks if the QoS for the request are satisfied by the node in steps S521 and S525. If not, node 12 sends a prune back packet in the direction of the source of the request in step S527. Otherwise, the resources are reserved tentatively for the incoming port of the request in step S531, and an assessment is made for every other port to determine if the requested route could be added to the tentative reserved route in the event the reserved path is confirmed. That is, the QoS of any equivalent reserved paths is assessed in steps S532. If any paths for which resources are tentatively reserved meet the QoS constraints for the incoming request (FIG. 5B-line 18), the incoming request is buffered in step S534 at the node.

Node 12 is said to enter into a pre-merge state for a particular request Req(M,I) when receiving one or more requests from different requesters to the same multicast tree. Depending on the outcome of QoS and hop distance tests, these later requests may be merged at the node without being repeated (example packet flow FIG. 9D) or be repeated as if they are normal requests (example packet flow FIG. 9E), if merging is not possible. A pre-merge is successful when a tentatively established outgoing branch for a preceding routing request can merge with the current requests upon the receipt of a confirmation message.

Specifically, assume Req(M,I) is the later request packet after the arrival of Req(M,H) at the same node. Suppose QoS_{A}(H) indicates a accumulated QoS parameter (for example, delay) and QoS_{Max}(H) the corresponding QoS constraint (accordingly, delay bound) of Req(M,H); Hop(H) and Hop_{Max}(H) indicate the hop count and hop bound of Req(M,H) respectively. The decision of the pre-merge node to merge Req(M,I) or to repeat it in the above example depends on the following conditions:

If [QoS_{Max}(I)−QoS_{A}(I)≦QoS_{Max}(H)−QoS_{A}(H)] and [Hop_{Max}(I)−Hop(I)≦Hop_{Max}(H)−Hop(H)]

then “wait Req(M,I)”

else “repeat Req(M,I)”

“wait Req(M,I)” signifies that the later request is waiting to use the routing result of the earlier request(s), instead of repeating it to the flooding ports.

It should be noted that in the illustrated packet flow of FIG. 9D, the incoming port of Req(M,H) has not gone through an QoS eligibility test by this node; hence Req(M,I) is preferably still repeated to this port if it meets the QoS requirements.

If this pre-merge node subsequently receives a message indicating one of the possible ports is unsuitable for request Req(M,H) (i.e. it receives a PrB(M,H) packet from one of the outport), the route to the port this packet arrived is also not suitable for Req(M,I). On the other hand, if the pre-merge node receives a confirm message (i.e. Cf(M,H) packet) to confirm its tentative reserved path, it performs one more test to confirm if the selected route has adequate QoS for the buffered requests, such as the Req(M,I), as detailed below. If not, the node sends a PrB(M,I) packet to prune the Req(M,I) immediately (packet flow-FIG. 11B), and passes on Cf(M,H). Otherwise it generates a Cf(M,I) to confirm the buffered request (FIG. 11C).

If the received request may not be merged with a pending route for this port, as determined in steps S532, the request is repeated downstream to all ports passed QoS tests in step S528. The PMRT at the node is updated accordingly (FIG. 5B-line 20). Corresponding packet flow is illustrated in FIG. 9E.

If no routes to the multicast are pending, as determined in step S524, the node 12 checks if the QoS for the request are met by the node in step S526 and S530. If not, a PrB packet is sent back to the upstream source of the request in step S533. Packet flow is again illustrated in FIG. 9F. Otherwise, the node reserves the resource tentatively and repeats the request to all of ports satisfying the QoS constraints of the incoming request, except the incoming port of the request, as in steps S528 and S529. Packet flow is illustrated in FIG. 9G.

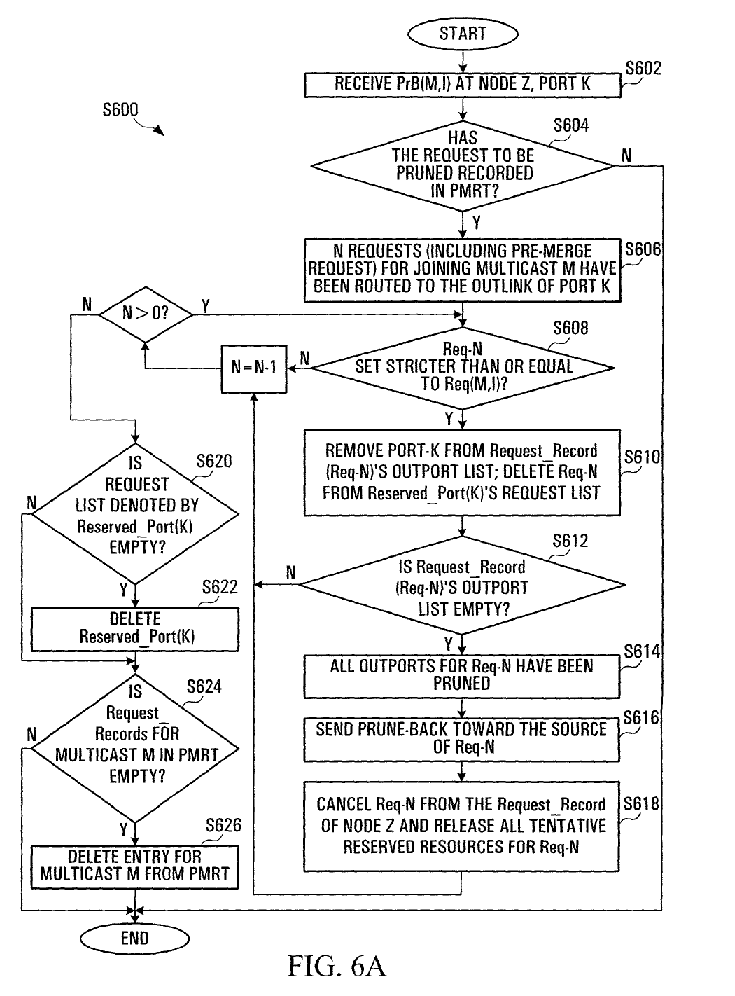

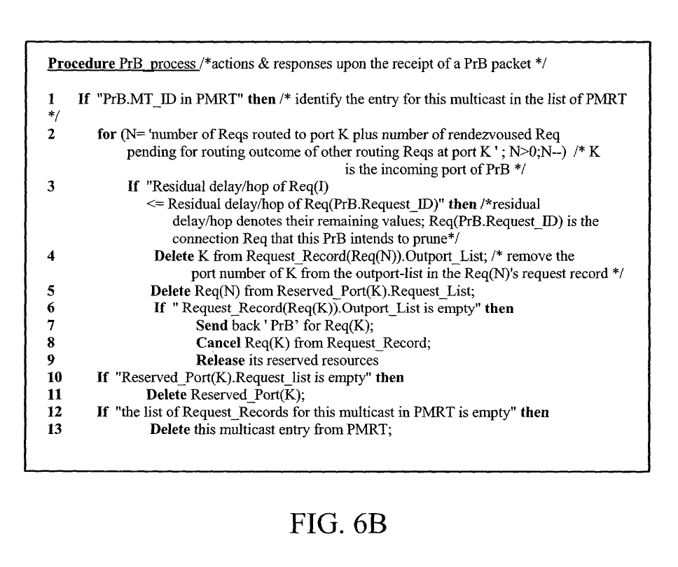

Steps S600 performed at a node upon receipt of a PrB packet are illustrated in FIG. 6A. PrB packets are processed (a) to release tentatively reserved resources reserved by the routing requests in pending (including pre-merging) requests, and (b) to further the prune back a the request, if necessary.

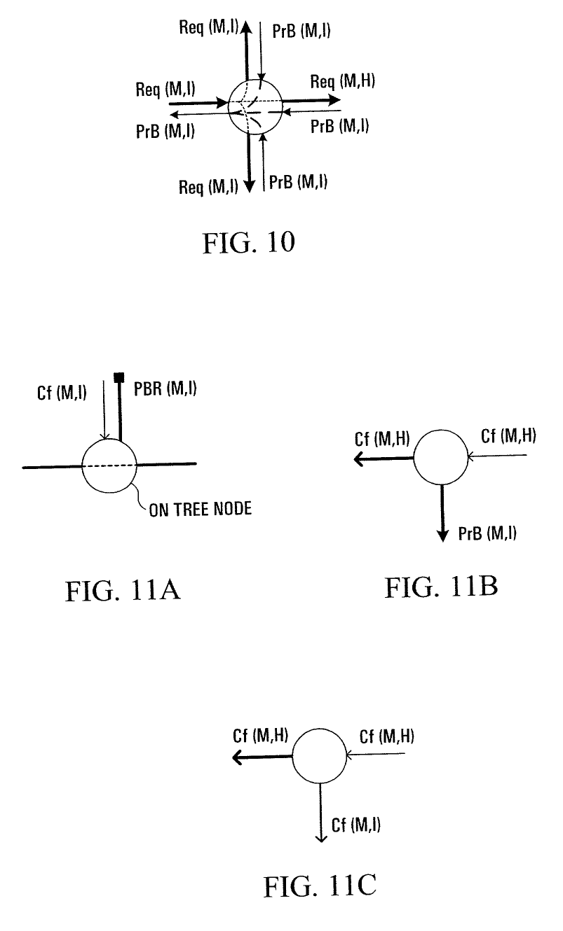

Upon receipt of a PrB(M,I) message in step S602 at a port (K), node 12 identifies a pending tree corresponding to the Req(M,I) in its PMRT in step S604 (FIG. 6B-line 1). Next, node 12 prunes Req(M,I) and all related pre-merges at port (K) whose QoS or other constraints were set stricter than those of Req(M,I) in loop of steps S608 to S618. Specifically, the node compares the QoS constraints of every request Req(M,N) routed to the port K to the requested QoS constraints of Req(M,I). If the QoS constraints are stricter, they would clearly not be met by the link at port K, and the port number K is deleted from the request-record's outport list for Req(M,N) (step S610 in FIG. 6A and FIG. 6B-line 4). If all routing outports for a particular request Req(M,N) have been deleted, node 12 dispatches a prune back packet (PrB) in the direction of the source of the deleted request Req(M,N) (Step 616 in FIG. 6A and FIG. 6B-line 6 and line 7), cancels the request from its request-record (FIG. 6B-line 8), and release its reserved resources (FIG. 6B-line 9) in step S618. When all requests to port K have been so pruned (FIG. 6B-line 10), as determined in step S620 (FIG. 6A), the node deletes the reserved port (FIG. 6B-line 11) in step S622. If all requests for this multicast at this node have been deleted as a result of loop steps S608-S618, as determined in step S624, the entry of for the multicast will be removed from the PMRT table of this node (FIG. 6B-line 13) in step S626. The corresponding packet flow is illustrated in FIG. 10.

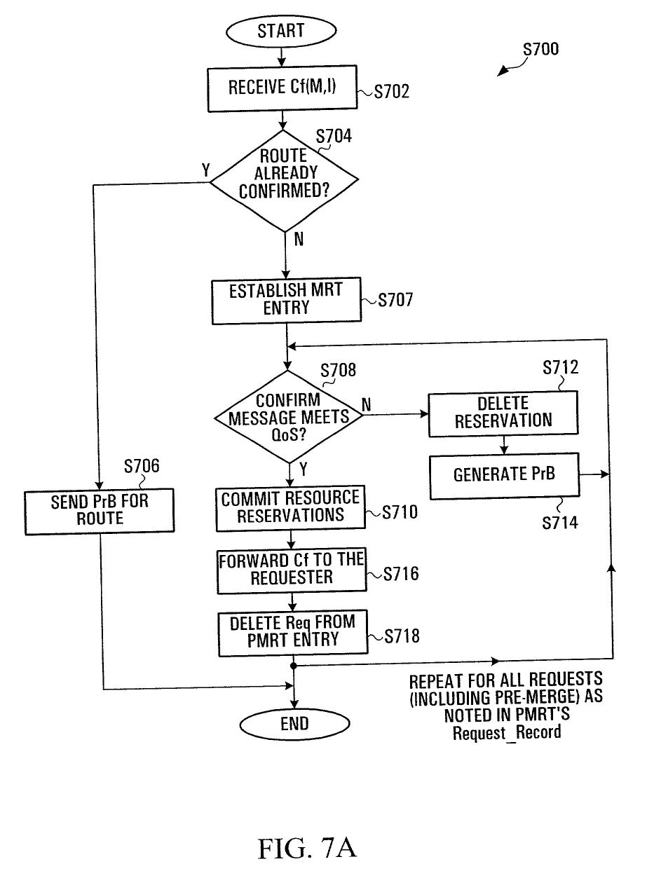

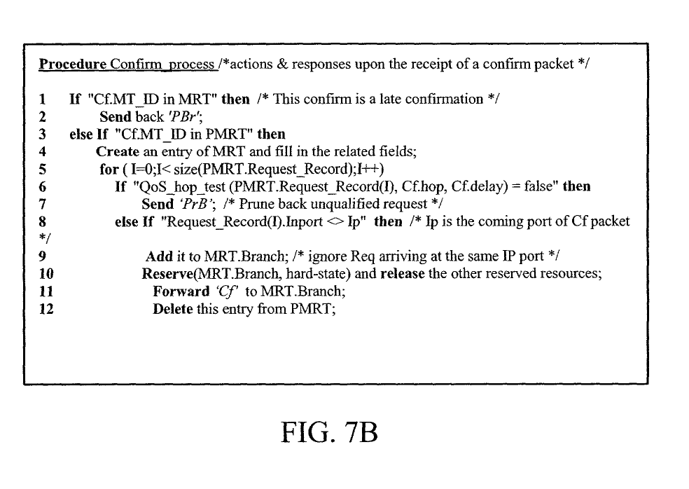

Receipt of confirm messages (Cf) commits tentatively reserved resources at a node 12, and thereby establishes an entry within the multicast routing table (MRT). Confirm messages are further propagated back toward the requester. Steps S700 processing confirm messages are illustrated in FIGS. 7A and 7B.

So, after receipt of a Cf message in step S702, node 12 determines if the confirm packet Cf(M,I) has a multicast ID (e.g. same source and channel) identical to one in its MTR in step S704. If so, it concludes the branch being confirmed is redundant and sends a prune-branch (PBR) packet (FIG. 7B-lines 1-2) in the direction of the originator of the Cf message, to prune that branch in step S706. In other words, if a node that is already on a multicast tree receives a Cf packet for the same multicast tree it means that this Cf packet is a late and hence undesirable confirmation. The node therefore causes a teardown of the portion of confirmed path toward the multicast source. Exemplary packet flow is illustrated in FIG. 11A.

It should be noted that any subsequent PrB(M,H) packet to Req(M,H) (processed in step S600 of FIG. 6A) will have no effect on a pre-merged buffered Req(M,I), as for example buffered in step S534 (FIG. 5A). Example packet flow is illustrated in FIG. 9F. However a Cf(M,H) packet leading to the confirmation of the earlier request Req(M,H) may also lead to confirmation of a buffered pre-merged Req(M,I). Therefore one more test confirms if the route confirmed by Cf(M,H) has adequate QoS for the a pre-merged Req(M,I) (S708). If not, the node sends a PrB(M,I) packet to prune the Req(M,I) immediately (S714); otherwise, it sends a ‘Cf(M,I)’ packet to confirm the Req(M,I) (S716).

If the request Req(M,I) corresponding to the received Cf(M,I) has not been recorded in the MRT, node 12 creates a new entry in the MRT in step S707. Now, every pending request that was not received from the port at which the Cf(M,I) message is received and satisfying the QoS constraints confirmed by the Cf message, as determined in step S708, is added to the MRT (FIG. 7B-line 9) in step S710. As well, reserved resources for the selected branch are confirmed (i.e. reserved in hard-state). A PrB packet is sent to prune back the request (FIG. 7B-line 7) to links identified by Cf that do not meet the QoS requirements of the request (FIG. 7B-line 6) in step S714, including any pre-merged requests awaiting confirmation of Req (M,I). Their resources are released in step S712 Next, the Cf is propagated to all the MRT branches (FIG. 7B-line 11) in step S716, including pre-merged branches (packet flow in FIG. 9H). As well, the corresponding entry in PMRT (FIG. 7B-line 12) is deleted in step S718.

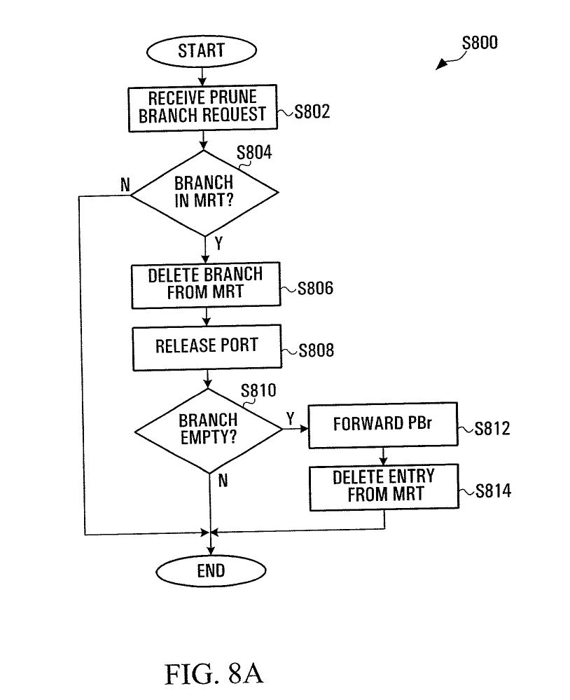

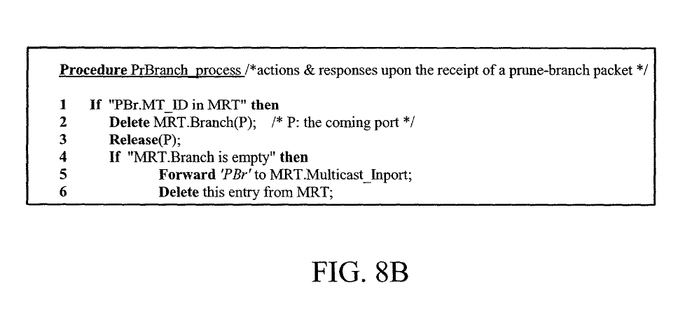

As noted, a node of an existing multicast tree triggers a prune branch process when it receives a second confirm packet to its earlier routed multicast routing request (see step S706 in FIG. 7A). A node receiving a prune branch (PBR) packet performs step S800 illustrated in FIG. 8A and is further detailed in FIG. 8B.

So after receipt of a message PBR(M,I) in step S802, a corresponding reserved route is identified in the MRT table in step S804. The branch corresponding to the port P on which PBR message arrived is deleted from the MRT table in step S806 (FIG. 8B-line 2). All the reserved resource at this port P for this connection (FIG. 8B-line 3) are also released in step S808. If there are no more branches on this node (FIG. 8B-line 4), as determined in step S810, the node will propagate backward the PRB toward the source of the multicast tree (FIG. 8B-line 5) in step S812. It then deletes the entry from the MRT (FIG. 8B-line 6) in step S814.

After joining a multicast, a computing device 14 acting as a receiver of a multicast (i.e. the former multicast route requester) may leave that multicast, at any time, asynchronously. To leave, a joined computing device 14 may leave the multicast and disconnect from the multicast tree by sending a prune-branch packet (PBR(M,I)) to its proximate edge node which is part of the multicast tree node. This node 12 receiving the prune branch message performs step S800 illustrated in FIG. 8A and is further detailed in FIG. 8B. Optionally, a ‘confirm disconnect’ message may be generated by the node to acknowledge to the disconnect request.

At each node, multiple QoS tests may be performed to asses if QoS constraints are met before a request is routed. For example, QoS tests may be performed in steps S518; S521, and the like. As noted example QoS constraints include, bandwidth, delay, and delay jitter. Other QoS constraints will be readily appreciated by those of ordinary skill. Example QoS tests may be performed as follows.

Bandwidth

A bandwidth check may be performed by verifying,

util(I)+QoS_{B}≦r(I)

where util(I) is the bandwidth that has already been reserved for QoS connection requests (both tentatively reserved and confirmed are included) for the link I and r(I) is its bandwidth capacity. QoS_{B} is the bandwidth requirement as specified in the request packet.

Delay

A delay check may be performed by verifying,

d_{Acc}+d_{G}≦QoS_{D}

where d_{Acc} is the accumulated delay from a leaf to the previous node, which may be updated in the Acc-Delay field of the request packet at each node; d_{G} is the computed ‘guaranteed delay bound’ between this node and the previous node; and QoS_{D} is a maximum allowed end-to-end delay QoS constraint.

The delay jitter test may be performed in a manner similar to the delay test. The computation of the guaranteed delay and delay jitter bounds may depend on the packet scheduling algorithm used in the node and the traffic load and behaviour at that point of consideration. For example, a class of Rate Proportional Schedulers (RPS) can guarantee an end-to-end delay bound, and delay jitter bound. The details of RPS can be found in D. Stiliadis and A. Varma, “Efficient Fair Queueing Algorithms for Packet-Switched Networks,” IEEE/ACM Trans. Networking, vol. 6, no. 2, pp. 175-185, April 1998; and D. Stiliadis and A. Varma, “Latency-Rate Servers: A General Model for Analysis of Traffic Scheduling Algorithms,” Proc. INFOCOM'96, pp. 111-119, April 1996.

Additionally, the number of hops travelled by any request packet may be limited in order to avoid undue routing traffic on network 10. For example, a request packet need not be repeated at a node (in for example steps S526) if the following condition is met:

Req.Hop_count≧Req_Max_hop

where Req.Hop_count is the total number of hops travelled by the request packet so far, and Req.Max_hop is the maximal permissible hop.

Alternatively, when an intermediate node receives a request packet, it may determine if this request can reach the root within the source-defined hop count limit according to the following distance test.

Req.Hop_count+DT(Req.Root)≦Req.Max_hop

where DT(Req.Root) is the minimal hop distance from this node to the root and Req.Max hop is a source-defined hop count limit (FIG. 4A). The determination of the hop count limit is a design decision. In general, this hop count limit can be given as the hop count of the n^{th} minimum-hop route (that is the n smallest distance) for a given pair of source and destination.

Additional bounding techniques based on the cost of communication could also be used at each node 12. For instance, a link cost may be associated according to its bandwidth. Suitable accumulated costs for a request may be added to request packets at nodes 12. This cost may be used together with the hop distance test as mentioned above, achieving a cost-bounded multicast routing control.

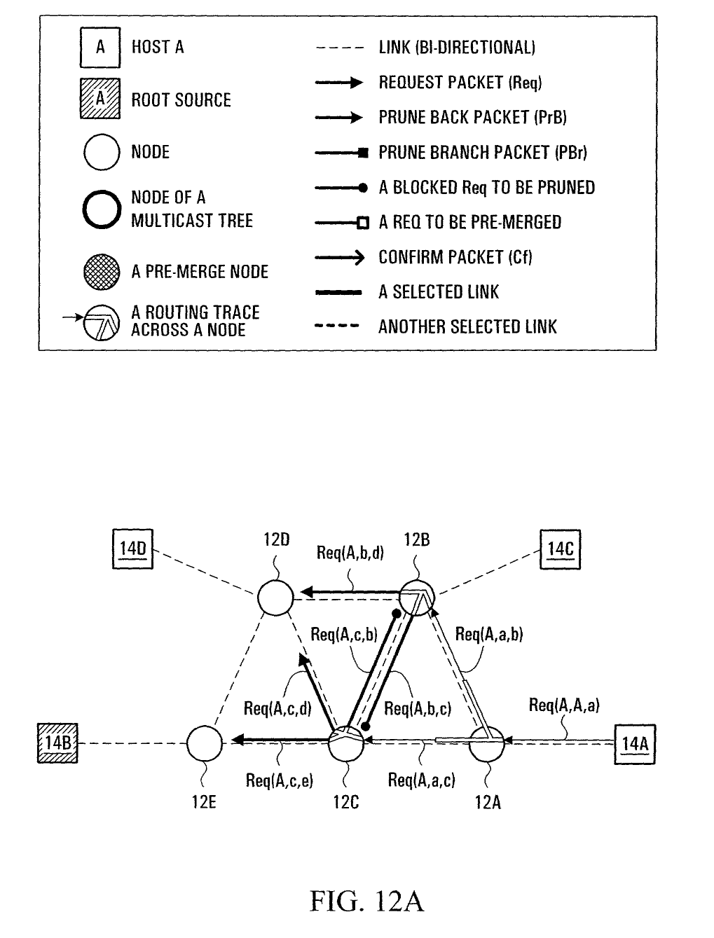

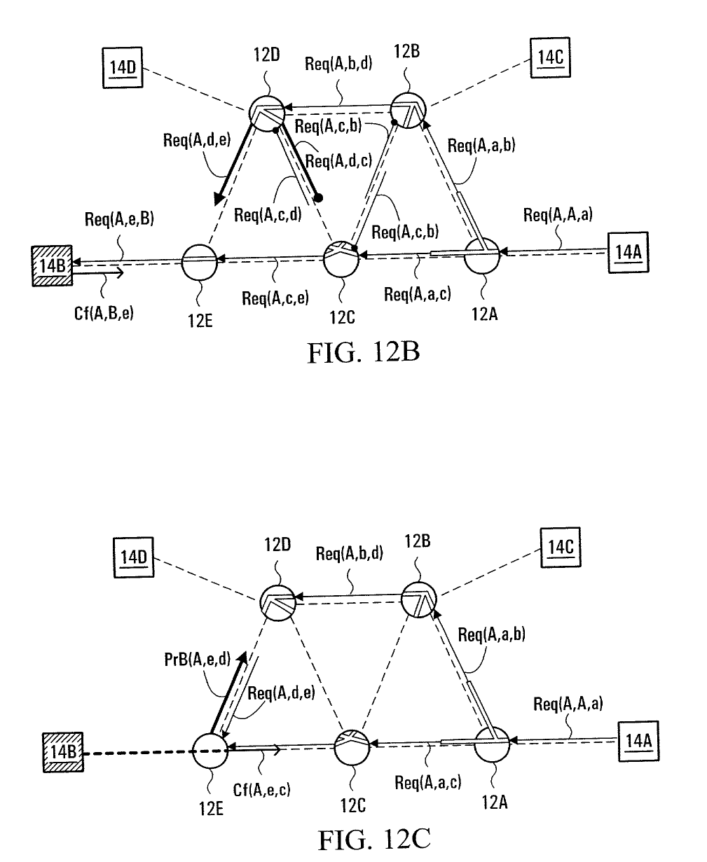

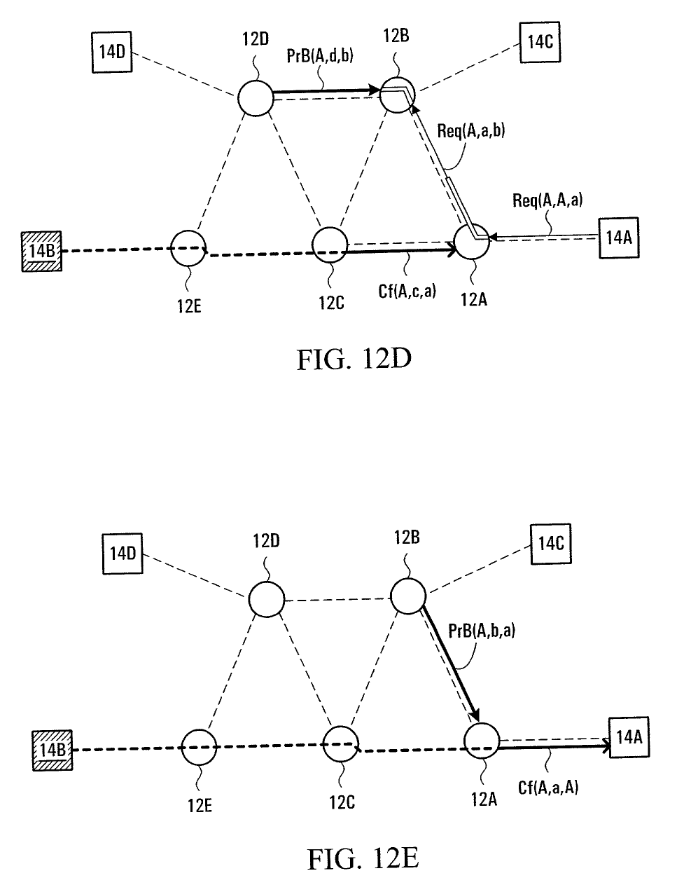

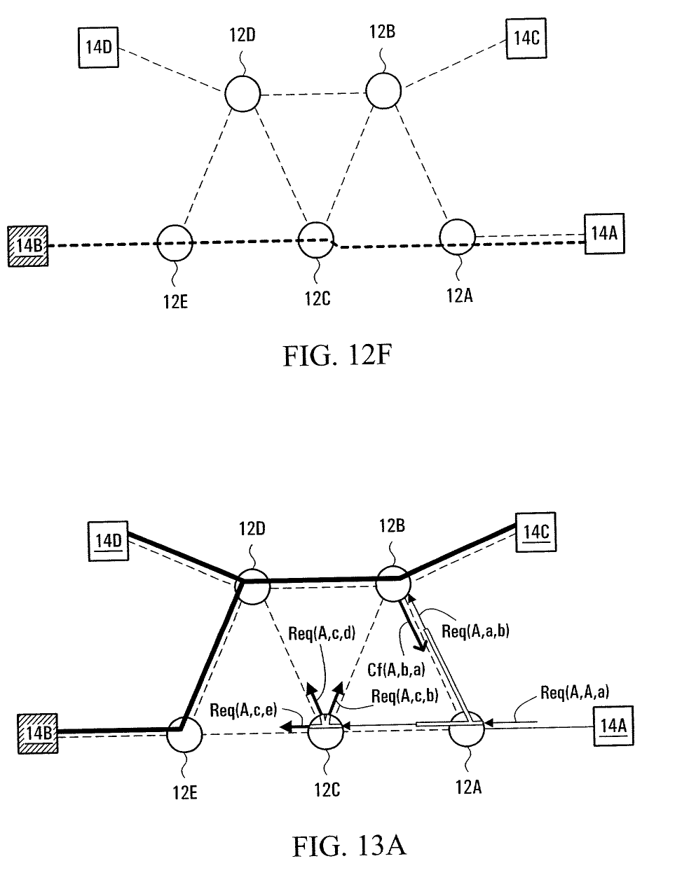

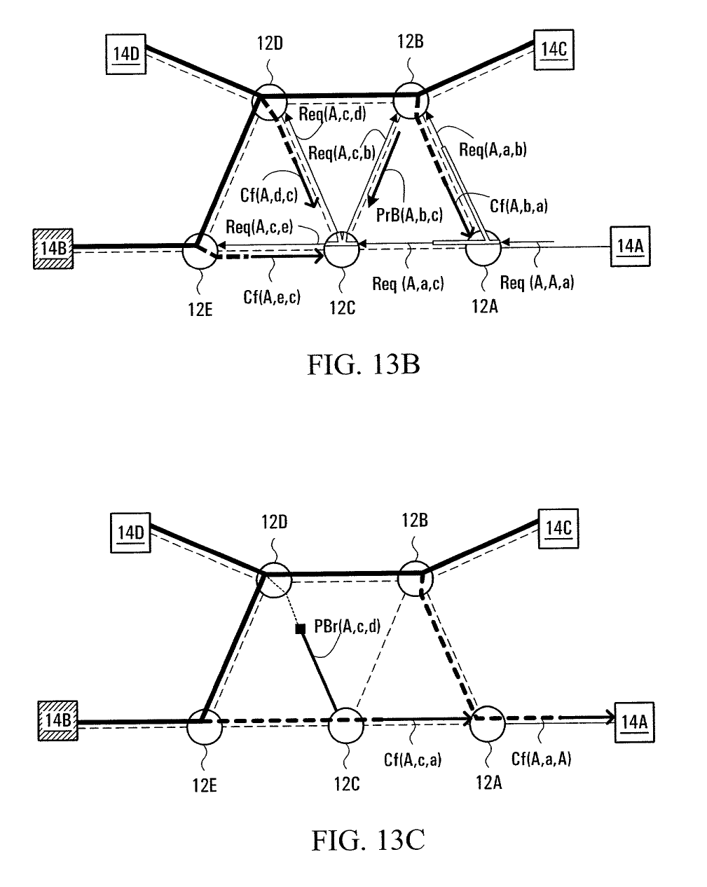

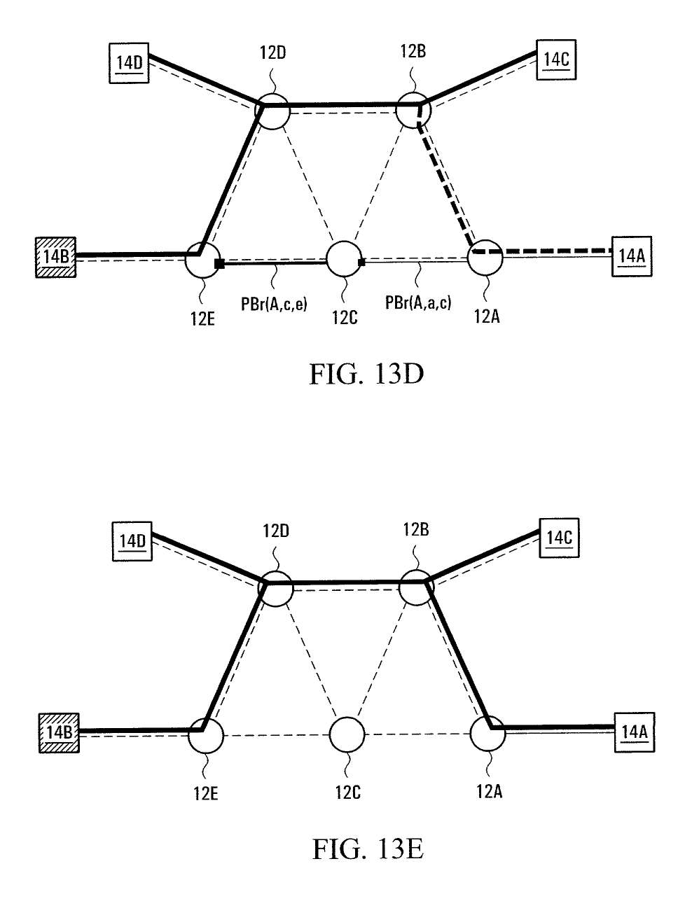

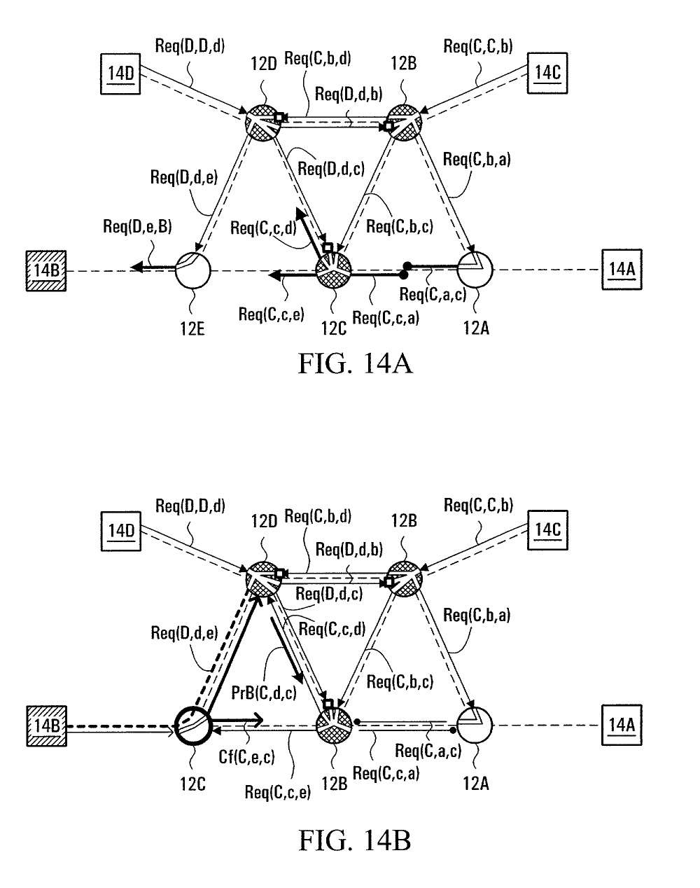

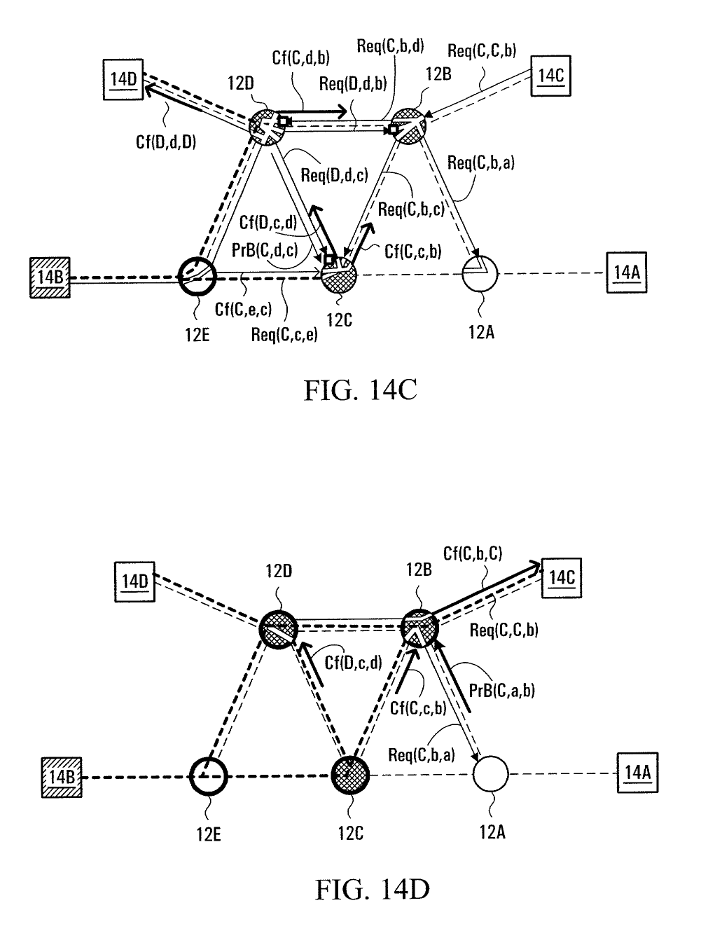

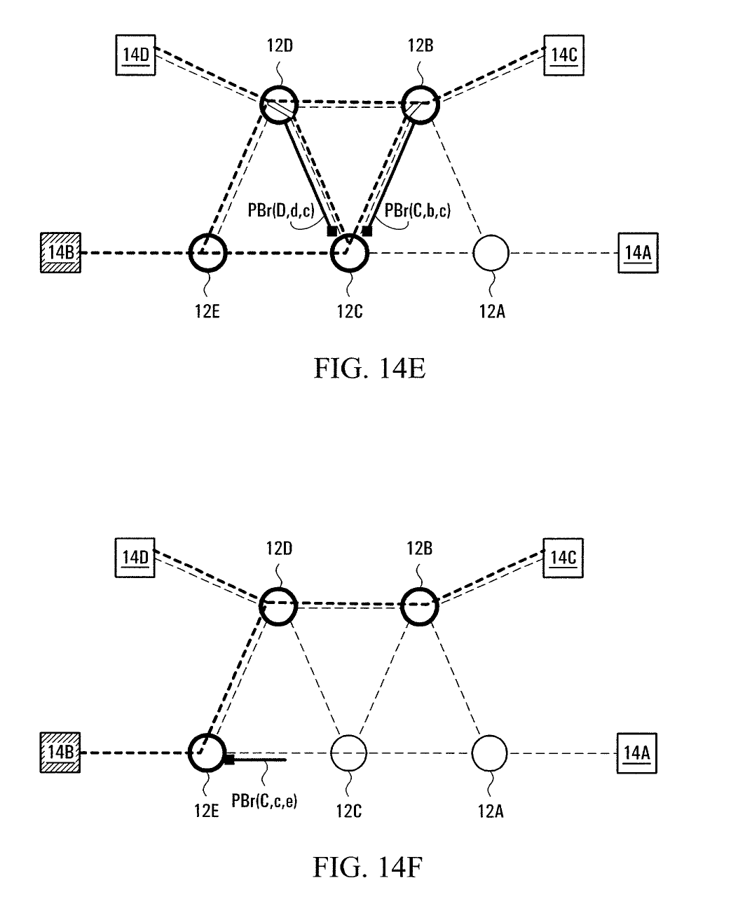

The above described multicast routing method may further be appreciated through three scenarios of receivers joining a multicast, illustrated in FIGS. 12-14. The legends for FIGS. 12 tol4 are shown in FIG. 12A.

Routing packets are identified using parameters (A,b,c) (e.g. Req(A,b,c)) for ease of explanation. The parameters in the brackets have the following meanings: the request packet is originally issued by user A (14a), is now being sent from node b (12b) to node c (12c). Note that the link is not dedicated to this route; it can be used by other connections.

FIGS. 12A-12B illustrate the routing processes of the first receiver to join a multicast service offered by a multicast source. The example assumes there exists a network multicast service directory through which information such as the sources, the multicast tree (session) identifiers, Tspec and source defined QoS can be obtained. A receiver to join a multicast should consult this usually well-known directory service prior to its multicast connection request, and include these constraints in the dispatched request.

In FIG. 12A, host A (14a) requests a multicast QoS connection to source B (14b). It sends a request packet Req(A,A,a) to the first hop node 12a, which triggers node 12a into routing this packet according to the steps S500 described with reference to FIGS. 5A and 5B. Briefly, if the routing request passes the node and link QoS tests (assume passing all QoS tests in all scenarios from hereon), the routing node 12a will repeat the request packet to the selected outports as Req(A,a,b) and Req(A,a,c) in this example (the faint branching lines within node 12a in FIG. 12A denote this routing action). Upon receiving the request packets, node 12b and node 12c route them in the similar way to their connecting nodes downstream: node 12c and node 12d; node 12b, node 12d and node 12e. The dark arrowed lines in FIG. 12A show the current request packets being routed. While routing a request packet, each node also adds an entry into its pending multicast routing table (PMRT) and tentatively reserves the required resources in ‘soft-state’, according to steps S500. Requests packets Req(A,c,b) and Req(A,b,c) are treated as implicit prune-back, as they are connection requests from the same requester.

In FIG. 12A, the request packet from node 12b (Req(A,b,d)) arrives at node 12d earlier than Req(A,c,d) from node 12c. In FIG. 12B, Node 12d repeats this request packet to node 12e and node 12c. As a result, both Req(A,c,d) and Req(A,d,c) are treated as implicit prune-back in FIG. 12B. Similarly, node 12c routes Req(A,c,e) to node 12e. Node 12e repeats the request packet to source B as it arrives there earlier than Req(A,d,e).

When source B receives the request packet and decides to accept the connection request, it sends back a connection confirm-packet (Cf(A,B,e)) immediately (FIG. 12B). This makes the link between source B and node 12b, which is marked by bold dotted line, to be a branch of multicast tree (FIG. 12C). After receiving a confirm packet, node 12e adds an entry to its Multicast Routing Table(MRT), deletes the entry from PMRT, reserves the resource in ‘hard-state’ and forwards the confirm-packet to node 12c.

This process is repeated at node 12c and node 12a, as shown in FIGS. 12D and FIG. 12E. As well, unsuccessful requests are pruned back by PrB packets, as shown in FIGS. 12C, 12D and 12E.

Thus a multicast QoS connection is established between hosts B and A, as shown in FIG. 12F.

FIGS. 13A-13E exemplify a new receiver joining an on-going multicast, in which there exists a multicast tree connected to other receivers.

In FIG. 13A, host A wishes to join the multicast of which host B is the root source. The existing multicast tree has two existing leaf members, host C and host D. After receiving a Req(A,A,a) from host A, node 12a routes the Request to node 12b and node 12c. Node 12b responds with a confirm packet Cf(A,b,a) according to steps S500 (FIG. 5A, 5B), as it is part of the existing tree. Node 12c repeats the request to node 12b, node 12d and node 12e, as shown in FIG. 13A.

As illustrated In FIG. 13B, node 12d and node 12e accept the request from node 12c and send confirm packets back, as they are part of the existing tree. Node 12b, on the other hand, will not accept the request Req(A,c,b) as it has confirmed the same connection request from A received earlier on as Req(A,a,b). Instead, node 12b generates a PrB(A,b,c) to prune-back the request packet Req(A,c,b) to node 12c. In the meantime, node 12a forwards the ‘Cf’ packet from node 12b to host A, which is said to have joined the multicast (FIG. 13C).

Although host A has joined the multicast tree within the shortest possible time, there remains some clean up to be performed. Assume node 12c receives Cf(A,e,c) first (FIG. 13B) and believes it is now part of the multicast tree. It forwards the ‘Cf’ packet to node 12a (FIG. 13C). It also sends a ‘Prune-Branch’ packet to prune the redundant branch between node 12c and node 12d when receiving Cf(A,d,c), according to the steps S800 (FIGS. 8A and 8B). When node 12a receives Cf(A,c,a) and finds that this is a late confirm packet (as node 12a has became part of the routing tree due to the previous confirm packet), it also sends back a PBr(A,a,c) according to the steps illustrated in FIGS. 7A and 7B to node 12c. Node 12c now has no out branch according, it forwards this ‘PBr(A,c,e)’ packet to node 12e, as shown in FIG. 13D. When node 12e receives the PBr, the process of cleaning up is completed (FIG. 13E).

FIGS. 14A-14F illustrate more than one (two in this example) receiver leaf joining a multicast source root concurrently.

In FIG. 14A, host C and host D request to join a multicast service with host B as the source, almost simultaneously. Hosts C and D send request packets to their respective leaf-node, node 12b and node 12d in this case. This triggers node 12b and node 12d into routing these request packets and resulting in resources being reserved in ‘soft-state’. Assume that the request Req(C,b,c) arrives at node 12c earlier than Req(D,d,c). Thus node 12c routes out this request to node 12a, node 12e and node 12d as Req(C,c,a), Req(C,c,e) and Req(C,c,d), as show in FIG. 14A. In addition, when node 12a receives Req(C,b,a), it sends Req(C,a,c) to node 12c. Hence Req(C,c,a) and Req(C,a,c) are treated as implict prune-back for node 12a and node 12c respectively Notice that the following request packets arrive at nodes each of which has involved in routing another connection request originated by a different receiver leaf: Req(C,b,d) at node 12d; Req(D,d,b) at node 12b, and Req(D,d,c) at node 12c. Nodes 12b, 12c and 12d are now ‘pre-merge’ nodes, which are partially shaded in FIG. 14A. The respective request waiting for a pre-merge is indicated with a small dark rectangular box in front of its arrow.

Suppose node 12e receives Req(D,d,e) first (FIG. 14 A). It repeats the request to the root source B as Req(D,e,B). Node 12e will not repeat Req(D) to node 12c as it has knowledge of the directly connected host, host B in this case. Root host B sends back a connection confirm packet Cf(D,B,e) when accepting the connection request (FIG. 14B). This is the only connection confirm packet needing to be generated by the source. Node 12e repeats this Cf to node 12d as Cf(D,e,d) to confirm the request Req(D,d,e). When node 12e subsequently receives Req(C,c,e) it generates a confirm packet Cf(C,e,c) to node 12c, as node 12e (indicated by the bolded circle in FIG. 14B) has become a node of the multicast tree.

In FIG. 14B Req(C,c,d) arrives at node 12d later than Req(C,b,d) which is a pre-merging request from the same receiver Hence, node 12e sends a PrB(C,d,c) to prune this blocked request.

In FIG. 14C, pre-merge node 12d simultaneously forwards Cf(D,d,D) to host D to confirm the Req(D,D,d) and Cf(C,d,b) to node 12b to confirm the pre-merge request Req(C,b,d). Note that the arrival of Cf(C,d,b) at node 12b will not trigger the acceptance of the pre-merging request Req(D,d,b) as they are both generated by node 12d (as specified in the confirmation steps detailed in FIGS. 7A and 7B). The pre-merge status at node 12b is lifted when node 12b becomes part of the multicast tree.

Meanwhile node 12c receives and accepts Cf(C,e,c) packet from node 12e. It becomes a node of the multicast tree, sends Cf(D,c,d) to confirm the pre-merage request Req(D,d,c) and Cf(C,c,b) to confirm the Req(C,b,c). Req(C,c,d) has now been pruned by PrB(C,d,c), and Req(C,b,a) is pruned by Prb(C,a,b).

In FIG. 14D node 12b repeats Cf(C,d,b) to host C as Cf(C,b,C) to confirm its request Req(C,C,b). Host C thus becomes a receiver leaf of the multicast.

In FIG. 14D, both Cf(D,c,d) and Cf(C,c,b) arrive at node 12d and node 12b respectively. These confirmations are redundant, as both nodes are part of the multicast tree. The redundant links between nodes 12c and 12b and nodes 12c and 12d are thus pruned by the prune branch process (steps S800-FIGS. 8A, 8B), which is accomplished at node 12b and node 12d by sending ‘PBr’ packets PBr(C,b,c) and PBr(D,d,c) as shown in FIG. 14E. Node 12c, after receiving both PBr packets, repeats it to node 12e as PBr(C,c,e). The final multicast tree is shown in FIG. 14F.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A method of operating a node within a packet switched network, comprising
receiving a route request to establish a multicast route through said node, said route request including an identifier of a multicast source and at least one quality of service constraint for a multicast from said source;
determining if another multicast route to said source satisfying said constraint and including said node is or may be established through said node;
merging said multicast route with said another multicast route to provide said multicast route through said node.

2. A method of operating a node within a packet switched network, in order to establish a route to a multicast source, said method comprising
receiving a route request at said node, said route request including at least one constraint for said route to said multicast source;
determining if another multicast route to said source satisfying said at least one constraint and including said node has been established through said node;
if no other multicast route to said source satisfying said constraint and including said node has been established through said node, repeating said route request downstream to ports of said node satisfying said at least one constraint.

3. The method of claim 2, further comprising tentatively reserving resources at said node corresponding to possible routes to be established through said node, and confirming tentatively reserved resources upon receipt of confirmation of a route through said node.

4. The method of claim 3, further comprising maintaining at said node, a table representing possibly reserved routes established through said node, and a table representing confirmed routes through said node.

5. The method of claim 4, wherein said confirming establishing entries in said table representing confirmed routes through said node, based on entries in said table representing possibly reserved routes established through said node.

6. The method of claim 2, wherein said at least one constraint comprises a hop constraint, representing a maximum number of hops that may be travelled by said route request.

7. The method of claim 2, wherein said route request comprises a hop counter, representative of hops travelled by said route request, and wherein said hop counter is indicative of whether said hop constraint may be met by said request.

8. The method of claim 2, wherein said at least one constraint comprises at least one of minimum bandwidth, minimum jitter delay, and minimum delay for said route.

9. The method of claim 5, wherein said determining if another multicast route to said source satisfying said at least one constraint comprises referring to said table representing confirmed routes through said node

10. In a communications network, in which multicast routes from a source may be established, a method of processing a route confirmation that is redundant at a node and deleting a corresponding branch on said network, said branch extending from said node to another node on an established path to said source, said method comprising:
receiving at said node, said route confirmation message confirming an earlier route requested to said source along said branch;
determining another multicast route to said source has already been established at said node prior to said receiving of said confirmation message and in response, dispatching a message along said branch, to delete reservations of resources for said branch on said network.

11. A method of establishing a multicast route at a node within a network comprising:
receiving a request to establish said route, said request including at least one constraint;
determining if reservation of resources along another route via said node to said source and satisfying said constraint, is pending;
buffering said request until said reservation of resources along said another route are confirmed;
upon confirming reservation of said resources along said another route at said node, merging said route with said another route from said node to said source.

12. The method of claim 11, further comprising dispatching a confirmation message, confirming confirmation of said route at said node, upstream along said route.

13. The method of claim 12, further comprising dispatching a confirmation message, confirming confirmation of said another route at said node, upstream along said another route.

14. A method of establishing a multicast route to a source, through a node within a communications network comprising:
receiving a confirmation message that said route may be established through said node, said confirmation message comprising an indicator for assessing QoS constraints along said route;
using said indicator to assess a QoS of said route from said source to said node;
committing previously tentatively reserved resources for other routes to said source through said node having quality of service constraints satisfied by said assessed quality of service;
releasing previously tentatively reserved resources for other routes to said source through said node having quality of service constraints not satisfied by said assessed quality of service.

15. The method of claim 14, wherein said indicator comprises an identifier of a said route.

16. The method of claim 15, wherein said indicator is used at said node to determine QoS constraints satisfied by said route, and known at said node.

17. The method of claim 14, further comprising sending messages along said network toward sources of said requests determined at said node their QoS constraints could not be meet by the quality of service indicated by the said confirmation message.

18. The method of claim 17, wherein said at least one constraint comprises at least one of minimum bandwidth, maximum jitter delay, hops bound, and maximum delay for said route.

19. A method of establishing a multicast route at a node within a network comprising:
receiving a request to establish said route, said request including at least one constraint;
determining said request is received from another node on an existing established route to said source;
discarding said request.

20. A method of operating a node within a packet switched network, in order to establish a route to a multicast source, said route including at least one port connecting said node to said network, said method comprising
receiving a message at said node, from a downstream node, indicating that a route through said port as requested by a route request will not meet a desired QoS;
releasing tentatively reserved resources for said port at said node, said tentatively reserved resources reserved for said route and for other routes having QoS constraints stricter than said desired QoS;
passing messages upstream along said route and said other routes, indicating tentatively reserved resources should be deleted upstream of said node.

21. A method of disconnecting a computing device from a multicast routing tree in a packet switched network, said method comprising
receiving a message to from said computing device, representative of multicast asynchronously;
repeating said message along a previously established branch connected to said tree;
releasing resources reserved at said node along said branch.

22. A method of establishing a multicast route satisfying at least one constraint, on a packet switched network, to transmit multicast data from a source to a receiver comprising:
originating a request to establish a route at said receiver;
flooding said request to nodes downstream of said receiver;
assessing if said at least one constraint is satisfied at said downstream nodes;
sending prune-back messages upstream toward said receiver, at nodes not satisfying said constraints;
forwarding said request downstream at nodes satisfying said constraint;
merging said route with an existing multicast route at a branch node along an existing multicast route toward said route, satisfying said constraints;
sending a confirmation message upstream toward said receiver from said branch node.

23. Computer readable medium storing processor readable instructions, that when loaded at a node within a packet switched communications, adapt said node to perform the method of claim 1.

24. Computer readable medium storing processor readable instructions, that when loaded at a node within a packet switched communications, adapt said node to perform the method of claim 2.

25. Computer readable medium storing processor readable instructions, that when loaded at a node within a packet switched communications, adapt said node to perform the method of claim 11.

26. Computer readable medium storing processor readable instructions, that when loaded at a node within a packet switched communications, adapt said node to perform the method of claim 14.

27. A network node within a packet switched network comprising:
a processor;
a plurality of ports, for communicating with said network;
memory storing processor readable instructions, adapting said node to perform the method of claim 2.
